(19) United States
(12) Patent Application Publication
(10) Pub. No.: US 2005/0134048 A1
(43) Pub. Date: Jun. 23, 2005

(54) GENERATING APPARATUS

(75) Inventors: Tateo Aoyama, Kakegawa-shi (JP); Takao Yoneyama, Kakegawa-shi (JP); Shunji Mochizuki, Kakegawa-shi (JP)

Correspondence Address: ERNEST A. BEUTLER, ATTORNEY AT LAW, 10 RUE MARSEILLE, NEWPORT BEACH, CA, 92660, US

(73) Assignee: Soqi Kabushiki Kaisha, Kakegawa-shi (JP)

(21) Appl. No.: 10/904,882

(22) Filed: Dec. 2, 2004

(30) Foreign Application Priority Data
Dec. 18, 2003 (JP) 2003-421705

(51) Int. Cl. B61C 9/38; B60L 11/02; H02K 23/52; G01L 9/00

(52) U.S. Cl. 290/1 A

(57) ABSTRACT

Several embodiments of prime mover driven electrical generators wherein the power output is increased without increasing the driving speed by driving both of the generator elements in opposite directions.

### BACKGROUND OF THE INVENTION

This invention relates to an electrical generating apparatus and more particularly to an improved generator that produces a large power output at a lower driven speed.

The use of electrical generators powered by a prime mover such as an internal combustion engine are well known. Although various constructions have been proposed, the generator normally is comprised of an armature having a number of ferromagnetic pole teeth around which electrical coils are wound. These coils or more particularly the pole teeth face a plurality of circumferentially spaced permanent magnets and one of the elements, generally the one carrying the magnets is rotated so as to induce a current flow through the coils.

Such an internal combustion engine driven generator is shown in Japanese Published Application JP Hei 8-80095. As is well known the amount of electrical power generated by such a generator is generally proportional to the speed at which it is driven. Therefore when large electrical power outputs are required, the speed of the driving engine is increased.

However when the engine speed is increased, the engine noise may become objectionable. This can be avoided if a step up transmission of some type is interposed between the engine and the generator to increase the rotational speed in relation to the engine speed, but the inertial force of the generator is proportional to the square of the speed at which it is driven, putting increased loading on the bearings and causing vibrations both of which will adversely affect the unit life and increase the need for servicing.

Therefore it is a principal object of the invention to provide a driven generator that can produce greater electrical power without requiring high rotational speeds achieved by either higher engine driving speeds or the use of step up transmissions.

### SUMMARY OF THE INVENTION

This invention is adapted to be embodied in an engine driven generator comprised of a first element comprising at least one permanent magnet and a second element having at least one pole tooth around which an electrical coil is wound. A prime mover arrangement is provided for driving both of the elements for rotation in opposite directions.

### BRIEF DESCRIPTION OF THE DRAWINGS

FIG. 1 is a side elevational view of an electrical generating apparatus constructed in accordance with a first embodiment of the engine with a portion of the electrical generator broken away to more clearly show the construction.

FIG. 2 is an enlarged view of the broken away portion in FIG. 1.

FIG. 3 is a view in part similar to FIG. 2 and shows another embodiment of the electrical generator.

FIG. 4 is a side elevational view, in part similar to FIG. 1 and shows a third embodiment of the invention.

FIG. 5 is an end elevational view taken in the direction of the arrow 5 in FIG. 4.

### DETAILED DESCRIPTION

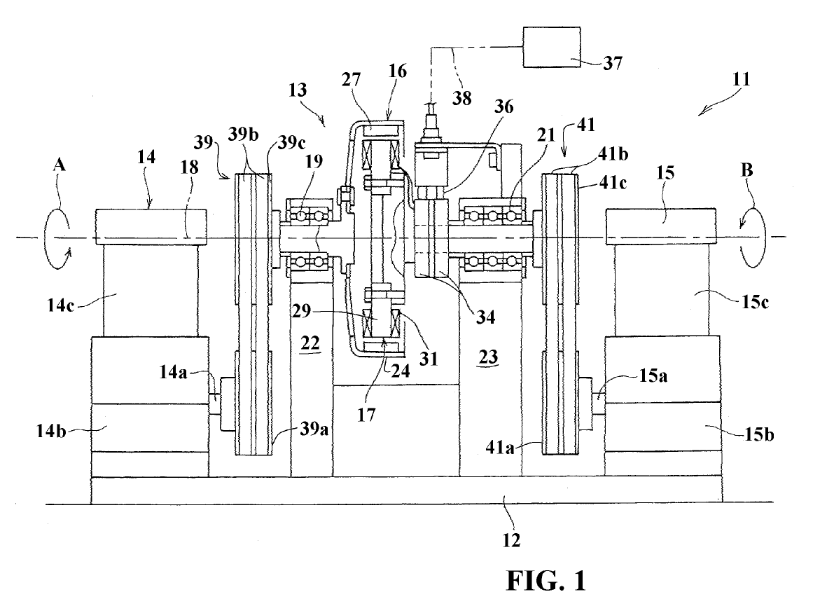

Referring now in detail to the drawings and initially to FIG. 1, an electrical generating apparatus constructed in accordance with a first embodiment is indicated generally by the reference numeral 11. The apparatus 11 includes a base 12 upon which an electrical generator, indicated generally by the reference numeral 13, is mounted in a manner to be described. The generator 13 is positioned, in this embodiment, between a pair of prime movers in the form of internal combustion engines 14 and 15 which are also supported on the base 12 in a suitable manner.

Preferably the engines 14 and 15 are of the same type, which may be suitable for producing the desired electrical power from the generator 13 for its intended purposes. Each engine has a respective crankshaft 14a and 15a journalled in the respective engine crankcase 14b and 15b and driven in a known manner by one or more pistons (not shown) reciprocating in respective cylinder blocks 14c and 15c.

As noted, preferably the engines 14 and 15 are of the same construction and the crankshafts 14a and 15a rotate in the same directions. However since the engines 14 and 15 face in opposite directions so the protruding ends of the crankshafts face toward the generator 13, their rotation will be in opposite directions as indicated by the arrows A and B respectively. The reason for this will become apparent shortly.

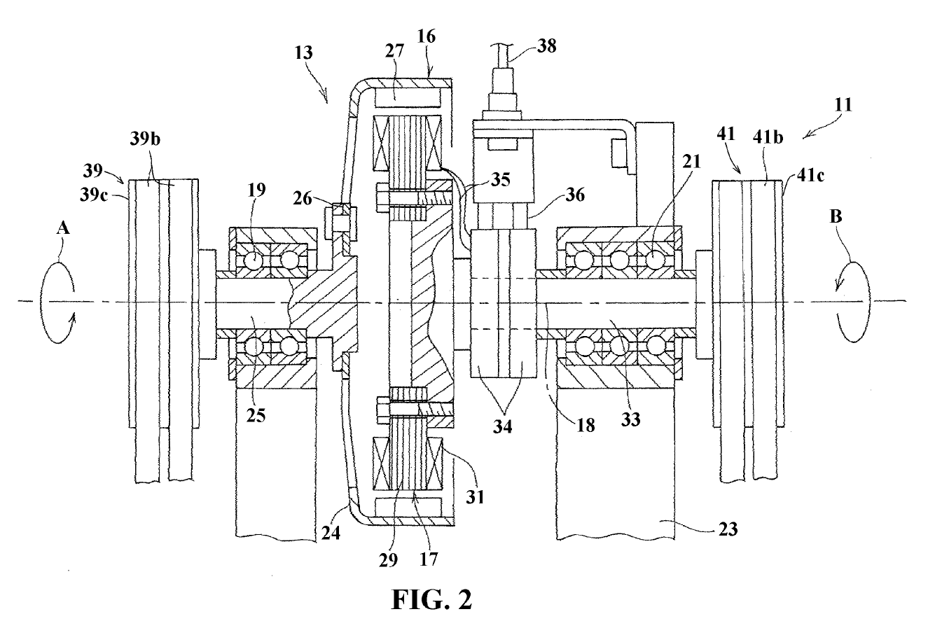

Turning now additionally to FIG. 2, the construction of the generator 13 will be described in detail. The generator 13 is comprised of first and second elements 16 and 17 that are supported for rotation about a common axis 18 by respective bearings 19 and 21. These bearings 19 and 21 are supported in respective upstanding posts 22 and 23 mounted on the base 12 between the engines 14 and 15 and on opposite sides of the generator 13

The first generator element 16 is comprised of a cup shaped shell 24. A stub shaft 25 is suitably fixed to an end wall 26 of the shell and is journalled for rotation about the axis 18 in the bearing 19. At least one and preferably more circumferentially spaced permanent magnets 27 of opposite plurality are suitably affixed to the interior of the cup shaped shell 24 in facing relation to the axis 18.

The second element 17 is comprised of an armature comprised of a laminated ferromagnetic core having a cylindrical inner portion 28 from which at least one and preferably a plurality of pole teeth 29 extend radially outwardly in confronting relation to the permanent magnets 27. Electrical coils 31 are wound around the pole teeth 29 in any manner known in the art.

The cylindrical inner portion 28 of the armature element 17 is fixed suitably, as by fasteners 32 to a second stub shaft 33 that is in turn journalled for rotation about the axis 18 by the bearing 21.

A pair of slip rings 34 are fixed to the stub shaft 33 between the bearing 21 and the cylindrical armature portion 28. Ends 35 of the coil windings 31 are led out through a hollow portion of the shaft 33 and connected to these slip rings in a suitable pattern. In the illustrated example two wire ends 35 and two slip rings 34 are shown, but it will be apparent to those skilled in the art that other winding arrangements are possible. Brushes 36 in a number equal to the number of slip rings 34 (two here) cooperate with slip rings 34 to deliver the generated electrical current to a load such as a storage battery 37 through a conductor 38. The brushes 36 and end of the conductor are carried by the post 23 in a known manner.

The generator elements 16 and 17 are driven from the engine shafts 14a and 15a respectively at the same speed and in opposite directions by respective belt transmissions, indicated generally by the reference numerals 39 and 41. Each of these transmissions is comprised, in this embodiment, by a driving pulley pair 39a and 41a coupled to the respective engine crankshaft 14a and 15a. These pulley pairs drive respective belt pairs 39b and 41b, that in turn drive driven pulley pairs 39c and 41c fixed for rotation with the stub shafts 25 and 33 respectively.

Since the generator magnet carrying element 16 and the coil carrying element 17 are driven at the same speed but in opposite directions the same electrical power output may be obtained as if one element was driven with the other one fixed at twice the speed. Hence it is possible to increase the electrical power without the high driving speeds previously required. This permits lower noise levels, reduces inertia and vibrations thus providing longer life and service intervals. In addition, if one of the engines 14 or 15 must be shut down for any reason, electrical power output may be obtained unlike the prior art arrangements.

In addition, by placing the slip rings 34 between the generator 13 and the post 23 the length of the wire ends 35 can be kept quite short simplifying the construction and reducing cost.

The foregoing description is based on the first embodiment of FIGS. 1 and 2. In addition to the possible modifications already discussed, the permanent magnets 27 may be replaced by electro magnets a voltage externally through slip rings. The common axis 18 may be vertical or tilted. In addition, the bearings 19 and 21 may be replaced with bushings. The generating apparatus also may be provided with three slip rings 34 to output a three-phase alternating current, or provided with five slip rings 34 to provide two different outputs such as a single-phase alternating current as in the case of the illustrated embodiment and a three-phase alternating current.

In addition the specifications of the first and second engines 14 and 15 may be freely selected in terms of number of cylinders, total displacement, engine layout, such as in-line type and V-type, and the like, or may be different from each other. In addition and as will be described shortly a single engine may be provided with a separate output shaft other than the crankshaft 5 or may be provided with two oppositely rotating output shafts.

Furthermore, the belt transmissions means may be replaced by toothed belts, chain type or a set of gears such as planetary gears.

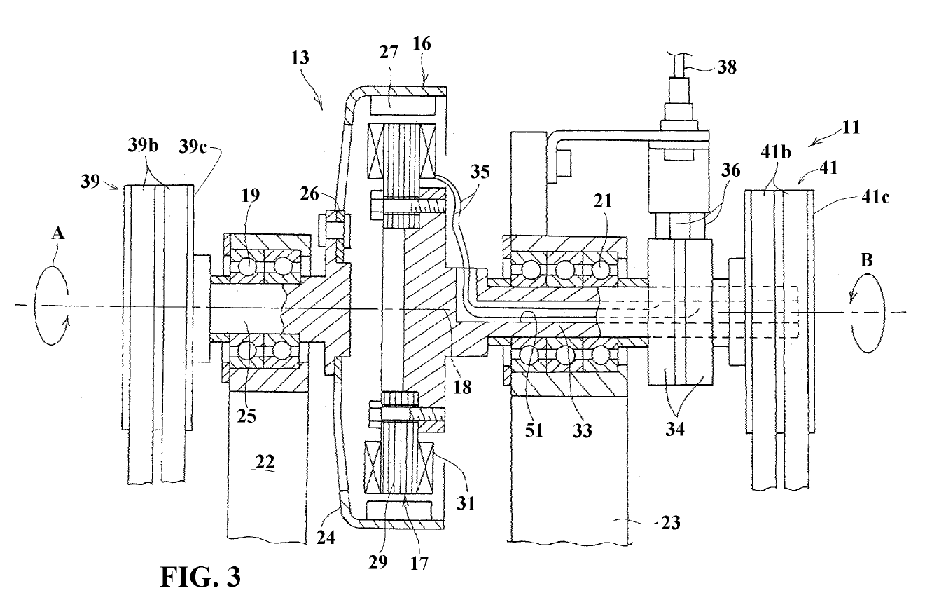

FIG. 3 is of the same area as shown in FIG. 2, but shows another embodiment. This embodiment differs from that previously described by reference to FIGS. 1 and 2 only in the location of the slip rings 34 and how the wire ends 35 are connected thereto. Since this is the only difference, like components are identified by like reference numerals and will be described again only insofar as is necessary to permit those skilled in the art to utilize this embodiment.

In this embodiment the slip rings 34 are positioned between the post 23 and the transmission 41. This permits the bearing 21 to be positioned closer to the stub shaft 33 to reduce cantilever loading. Thus the stub shaft 33 is provided with an elongated opening 51 to permit attachment of the wire ends 35 to the slip rings 34.

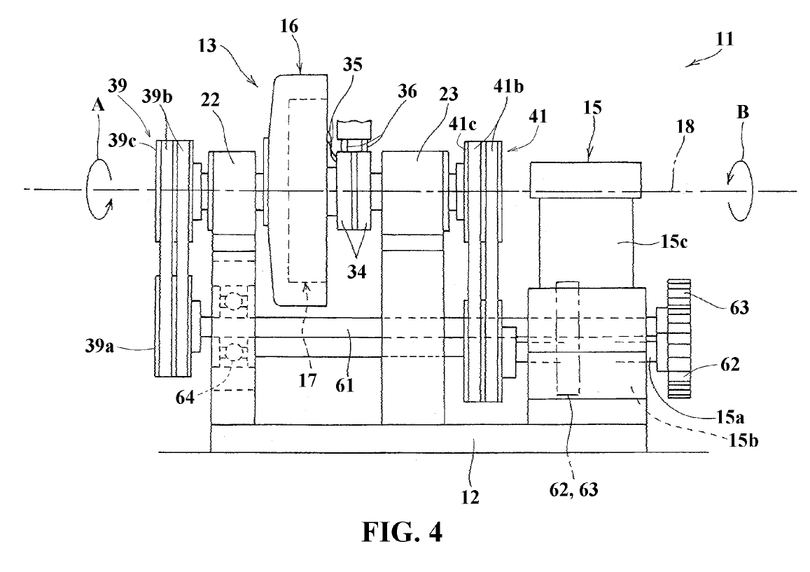

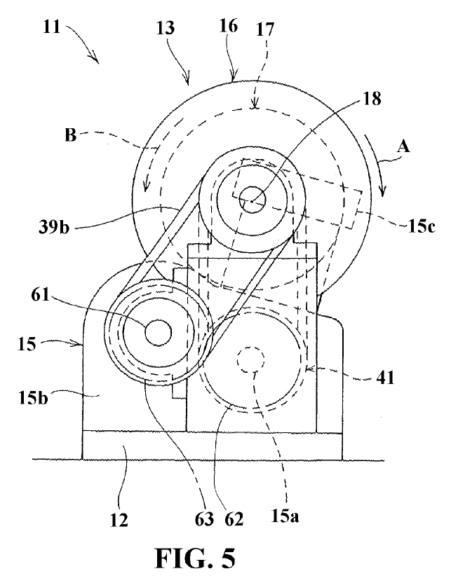

As previously mentioned, it is not necessary to drive the elements 16 and 17 of the generator 13 in opposite directions by two separate prime movers. That is in many cases an engine has itself two shafts that are driven at the same speed, but in opposite directions. These two shafts may be employed for driving the generator elements and FIGS. 4 and 5 show such an embodiment. Because this is the only difference from the embodiments previously described, where elements have the same or substantially the same construction they have been identified by like reference numbers and will be described again only to make the construction and operation of this embodiment clear to those skilled in the art.

As seen in this embodiment the generator 13 has the same elements as already described and is mounted on the base 12 between the posts 22 and 23 with the slip rings 34 and brushes 36 at one end of the generator 13 between these posts 22 and 23.

A single engine 15 is placed on the other side of the post 23 from the generator 13 and as in the previously illustrated embodiments is driven by the belt transmission 41 from the engine crankshaft 15a. In this case the engine 15 has its cylinder block 15c inclined slightly from the vertical for a reason that will become apparent shortly.

In this case the engine 15 has a further shaft 61, which may comprise a balancer shaft that rotates at the same speed as the crankshaft 15a but in the opposite direction. This is done by a pair of intermeshing gears 62 and 63 positioned, for example, externally of the body of the engine 15, as shown in solid lines or internally as shown in broken lines.

In accordance with this embodiment the balancer shaft 61 is extended beyond the engine body to pass one side of the post 23, because of the offset of the engine body from the vertical and be journalled in the post 22 by a bearing 64 and drive the magnet carrying element 16 of the generator 13 through the transmission 39 at the same speed as the armature element 17, but in the opposite direction. Thus with this embodiment only one engine is required.

Thus from the foregoing description it should be readily apparent that the described embodiments provide a generator arrangement wherein large electrical power outputs are possible without requiring high driving speeds with the attendant disadvantages. Of course those skilled in the art will readily understand that the described embodiments are only exemplary of forms that the invention may take and that various changes and modifications may be made without departing from the spirit and scope of the invention, as defined by the appended claims.

1. An engine driven generator comprised of a first element comprising at least one permanent magnet and a second element having at least one pole tooth around which an electrical coil is wound, and a prime mover arrangement for driving both of the elements for rotation in opposite directions.

2. An engine driven generator as set forth in claim 1 wherein a first prime mover shaft drives the first element in one direction and a second prime mover shaft drives the second element in a second direction opposite to the first direction.

3. An engine driven generator as set forth in claim 2 wherein the first element has a plurality of circumferentially spaced permanent magnets and the second element has a plurality of circumferentially spaced pole teeth around which coils are wound.

4. An engine driven generator as set forth in claim 3 further comprising a plurality of slip rings connected to ends of the coils are fixed for rotation with the second element.

5. An engine driven generator as set forth in claim 4 wherein a journaling bearing for the second element is interposed between the second element and the slip rings.

6. An engine driven generator as set forth in claim 2 wherein the first and second prime mover shafts are each driven by a respective first and second prime mover.

7. An engine driven generator as set forth in claim 6 wherein the first and second prime movers have the same construction and rotate in the same direction and face opposite ends of the generator to drive the elements in opposite directions.

8. An engine driven generator as set forth in claim 2 wherein the first and second prime mover shafts are driven by a common prime mover.

9. An engine driven generator as set forth in claim 8 wherein the first and second prime mover shafts are coupled for rotation within the body of the prime mover and both shafts extend externally of the engine body to drive the generator elements through respective first and second transmissions.
